(19) United States
(12) Patent Application Publication
(10) Pub. No.: US 2004/0124955 A1
(43) Pub. Date: Jul. 1, 2004

(54) High frequency substrate

(76) Inventors: Sung-Mao Wu, Kaohsiung (TW); Kun-Ching Chen, Tainan (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/712,524

(22) Filed: Nov. 13, 2003

(30) Foreign Application Priority Data
Dec. 31, 2002 (TW) 091138176

(51) Int. Cl. H01P 3/08

(52) U.S. Cl. 333/238

(57) ABSTRACT

A high frequency substrate comprises at least a metal layer, a dielectric layer and a high frequency signal transmission line is provided. Of which, the dielectric layer, which is formed on the metal layer, has a dense structure and a number of closed voids with a filling material stuffed therein. Since the dielectric constant of a material is smaller than that of the dense structure, the overall dielectric constant of the dielectric layer is smaller than that of the dense structure. When the high frequency signal transmission line is deposited on the dielectric layer, the signal transmission speed in the high frequency signal transmission line will be improved, the energy loss of signals will be attenuated and so will signal transmission quality be maintained.

This application claims the benefit of Taiwan application Serial No. 91138176, filed, Dec. 31, 2002.

### BACKGROUND OF THE INVENTION

1. Field of the Invention

The invention relates in general to a high frequency substrate, and more particularly, to a high frequency substrate having a dielectric layer with the design of closed voids.

2. Description of the Related Art

While wireless network and satellite communication are gaining rapid growth, electronic products tend to have the design of high speed, high frequency and high capacity. Consequently, the present electronic products need to have the support of a high frequency substrate in order that a high frequency and high speed performance can be achieved.

Please refer to FIG. 1, the cross-sectional view of a conventional high frequency substrate. In FIG. 1, the high frequency substrate 100 comprises a ground plane 102, a dielectric layer 104 and a high frequency signal transmission line 106, wherein the dielectric layer 104 is formed on the ground plane 102 while the high frequency signal transmission line 106 is deposited on the dielectric layer 104. Of which, the dielectric constant of the air outside the high frequency signal transmission line 106 is 1 while the dielectric constant of the dielectric layer 104 is εᵣ wherein the value of εᵣ being greater than 1, say 4 for instance. Besides, the dielectric layer 104 is normally a dense structure.

Suppose that the signal transmission speed in the high frequency signal transmission line 106 is Vp, then VP=C/(ε_{eff})^{1/2}, wherein C is the speed of the light while ε_{eff} is the effective dielectric constant. That is to say, the signal transmission speed Vp is inversely proportional to the square root of the effective dielectric constant ε_{eff}. It is noteworthy that ε_{eff} varies with the intensity of signal transmission frequency. In other words, an electromagnetic field will be generated during signal transmission. Of which, the dielectric constant for the medium of the high electromagnetic area can be regarded as ε_{eff}.

Unlike in the case of low-frequency operation where the electromagnetic field generated during signal transmission concentrates in the air outside the high frequency signal transmission line 106, the electromagnetic field generated during signal transmission almost entirely concentrates in the dielectric layer 104 because the high frequency signal transmission line 106 normally has a high frequency of signal transmission. So the effective dielectric constant ε_{eff} approximately equals to the dielectric constant εᵣ of the dielectric layer 104. For instance, the value of ε_{eff} equals 4. Hence, the signal transmission speed Vp will slow down, which increases the energy loss of signals and in turn affects signal transmission quality greatly.

### SUMMARY OF THE INVENTION

It is therefore an object of the invention to provide a high frequency substrate having a dielectric layer with closed voids, which can reduce the dielectric constant of a conventional dielectric layer. Hence signal transmission speed will be improved, the energy loss of signals will be attenuated and signal transmission quality will be maintained.

It is therefore another object of the invention to provide a high frequency substrate comprises at least a metal layer, a dielectric layer and a high frequency signal transmission line, wherein the dielectric layer, which is formed on the metal layer, has a dense structure and a number of closed voids with a filling material stuffed therein. Since the dielectric constant of a material is smaller than that of the dense structure, the overall dielectric constant of the dielectric layer is smaller than that of the dense structure. When the high frequency signal transmission line is deposited on the dielectric layer, the signal transmission speed in the high frequency signal transmission line will be improved, the energy loss of signals will be attenuated and so will signal transmission quality be maintained.

It is therefore another object of the invention to provide a high frequency substrate comprises at least a metal layer, a dielectric layer and a high frequency signal transmission line, wherein the dielectric layer, which is formed on the metal layer, has a dense structure and a number of closed voids with air stuffed therein. Since the dielectric constant of the air is smaller than that of the dense structure, the overall dielectric constant of the dielectric layer is smaller than that of the dense structure. When the high frequency signal transmission line is deposited on the dielectric layer, the signal transmission speed in the high frequency signal transmission line will be improved, the energy loss of signals will be attenuated and so will signal transmission quality be maintained.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 shows the cross-sectional view of a conventional high frequency substrate; and

FIG. 2 shows the cross-sectional view of a high frequency substrate according to the preferred embodiment of the invention.

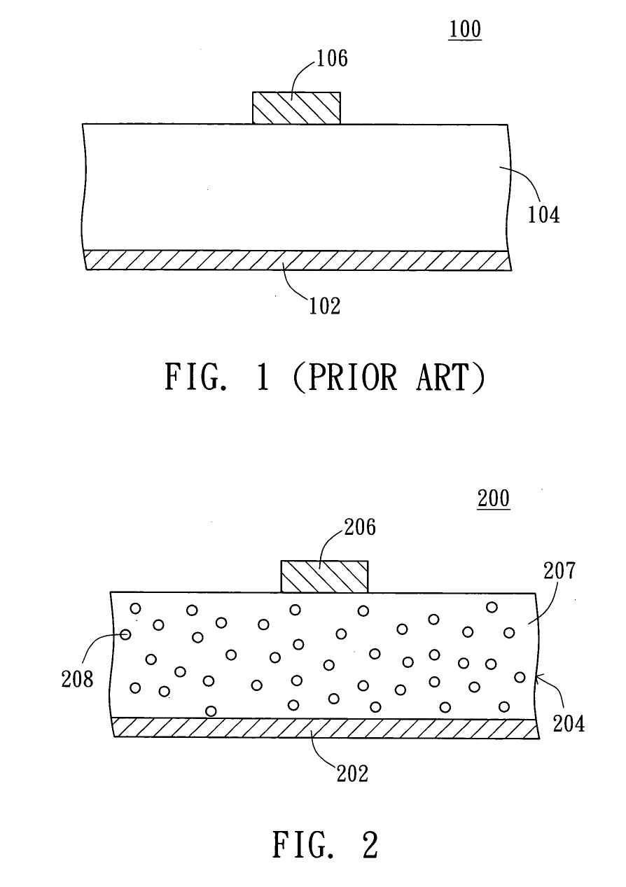

### DETAILED DESCRIPTION OF THE INVENTION

The dielectric layer of the high frequency substrate according to the present invention, which has the design of voids, for example, closed voids, not only improves signal transmission speed, but also attenuates energy loss of signals and maintains signal transmission quality.

Please refer to FIG. 2, the cross-sectional view of a high frequency substrate according to the preferred embodiment of the invention. In FIG. 2, the high frequency substrate 200 at least comprises a metal layer 202, a dielectric layer 204 and a high frequency signal transmission line 206. Of which, the dielectric layer 204 is formed on the metal layer 202 while the dielectric layer 204 has a dense structure 207 and a number of closed voids 208 with a material stuffed therein. Since the dielectric constant of the air inside the closed void 208 of the dielectric layer equals 1, the overall dielectric constant of the dielectric layer 204 will be smaller than that of the dense structure 207. Moreover, the more closed voids there are, which means a larger volume of air is contained inside the dielectric layer 204, the smaller the overall dielectric constant of the dielectric layer 204 will be.

When the high frequency signal transmission line 206 is deposited on the dielectric layer 204, according to the relation that signal transmission speed is in inverse proportion to the square root of the dielectric constant, the signal transmission speed in the high frequency signal transmission line 206 will speed up because the overall dielectric constant of the dielectric layer 204 becomes smaller. Thus the energy loss of signals will be attenuated and a high speed and high frequency signal transmission can be achieved.

Anyone who is familiar with the technology of the invention will not be limited to the above embodiment. For example, the metal layer 202 can be the ground plane or the power plane. Of which, the material for the dielectric layer can be polytetrafluroethylene (PTFE), the ceramics, resins or heat-resistant foaming materials.

Furthermore, according to the design of the present invention, the air can be pumped into the dense structure 207 prior to its solidification to form a number of bubbles on the dielectric layer 204. After solidification, the dielectric layer 204 will have closed voids 208 containing air inside.

The dielectric layer of the high frequency substrate according to the invention disclosed, having the design of closed voids, reduces the dielectric constant of a conventional dielectric layer. Not only can signal transmission speed be improved, but also the energy loss of signals be attenuated and signal transmission quality be maintained.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A high frequency substrate comprising at least:
a metal layer;
a dielectric layer formed on the metal layer, wherein the dielectric layer has a dense structure and a plurality of voids with a filling material stuffed therein wherein the dielectric constant of the filling material is smaller than that of the dense structure so that the overall dielectric constant of the dielectric layer is smaller than that of the dense structure; and
a high frequency signal transmission line, which is deposited on the dielectric layer.

2. The high frequency substrate according to claim 1, wherein the metal layer is a ground plane.

3. The high frequency substrate according to claim 1, wherein the metal layer is a power plane.

4. The high frequency substrate according to claim 1, wherein a material of the dielectric layer is polytetrafluroethylene (PTFE).

5. The high frequency substrate according to claim 1, wherein a material of the dielectric layer is ceramics.

6. The high frequency substrate according to claim 1, wherein a material of the dielectric layer is resins.

7. The high frequency substrate according to claim 1, wherein a material of the dielectric layer is foaming materials.

9. The high frequency substrate according to claim 1, wherein the filling material is air.

10. A high frequency substrate comprising at least:
a metal layer;
a dielectric layer formed on the metal layer, wherein the dielectric layer has a dense structure and a plurality of voids with air stuffed therein; and
a high frequency signal transmission line which is deposited on the dielectric layer.

11. The high frequency substrate according to claim 10, wherein the metal layer is a ground plane.

12. The high frequency substrate according to claim 10, wherein the metal layer is a power plane.

13. The high frequency substrate according to claim 10, wherein a material of the dielectric layer is polytetrafluroethylene (PTFE).

14. The high frequency substrate according to claim 10, wherein a material of the dielectric layer is ceramics.

15. The high frequency substrate according to claim 10, wherein a material of the dielectric layer is resins.

16. The high frequency substrate according to claim 1, wherein a material of the dielectric layer is foaming materials.

17. The high frequency substrate according to claim 1, wherein a material of the dielectric layer is heat-resistant materials.
